(19) United States
(12) Patent Application Publication
(10) Pub. No.: US 2010/0222060 A1
(43) Pub. Date: Sep. 2, 2010

(54) ANCHOR CARRIER RESELECTION AND CELL RESELECTION IN LONG TERM EVOLUTION-ADVANCED

(75) Inventors: Guodong Zhang, Syosset, NY (US); Jin Wang, Princeton, NJ (US); Peter S. Wang, E. Setauket, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/710,743

(22) Filed: Feb. 23, 2010

Related U.S. Application Data
(60) Provisional application No. 61/156,091, filed on Feb. 27, 2009.

(51) Int. Cl. H04W 36/34

(52) U.S. Cl. 455/436

(57) ABSTRACT

A method and apparatus for performing anchor carrier reselection measurements and ranking in Long Term Evolution-Advanced are disclosed. The measurements are first determined by whether a non-serving anchor carrier has a higher reselection priority than a serving anchor carrier. Other non-serving anchor carrier measurements are started by checking the serving anchor measured results against non-serving anchor carrier measurement thresholds, including the parameter S-IntraCellSearch for measuring and ranking the intra-cell anchor carriers ahead of other non-serving anchor carriers.

### CROSS REFERENCE TO RELATED APPLICATION

This application claims the benefit of U.S. Provisional Patent Application No. 61/156,091, filed Feb. 27, 2009, which is incorporated by reference as if fully set forth herein.

### FIELD OF INVENTION

This application is related to wireless communications.

### BACKGROUND

In the Long Term Evolution (LTE) downlink (DL) direction, a wireless transmit/receive unit (WTRU) may receive its signal anywhere across the frequency domain in the whole LTE transmission bandwidth. In the uplink (UL) direction, the WTRU may transmit only on a limited, yet contiguous set of assigned sub-carriers in a frequency division multiple access (FDMA) arrangement, such as Single Carrier (SC) FDMA. Only for illustration purposes, if the overall orthogonal frequency division multiplexing (OFDM) signal or system bandwidth in the UL is composed of useful sub-carriers numbered 1 to 100, a first WTRU may be assigned to transmit on sub-carriers 1-12, a second WTRU may transmit on sub-carriers 13-24, and so on. An evolved Node B (eNodeB or eNB) may receive the composite UL signal across the entire transmission bandwidth from one or more WTRUs at the same time, but each WTRU may only transmit into a subset of the available transmission bandwidth. FIG. 1 shows the sub-carrier operations in a Release 8 (R8) single carrier and as such, each LTE cell consists of a single pair of carriers, one for uplink and one for downlink.

One improvement proposed for LTE-Advanced (LTE-A) is carrier aggregation and support for a flexible bandwidth arrangement. An LTE-A eNB transmits and receives over a wider frequency spectrum than an LTE cell, up to 100 MHz, and consists of several frequency carriers (called component carriers in LTE-A) that an LTE-A carrier/cell set may normally use. This is called bandwidth extension or multi-carrier aggregation for an LTE-A eNB as the cell coverage. One motivation for aggregation is to allow DL and UL transmission bandwidths to exceed 20 MHz in R8 LTE, e.g., 40 MHz. A second motivation for aggregation is to allow for more flexible usage of the available frequency spectrum. For example, whereas R8 LTE is limited to operate in symmetrical and paired frequency division duplex (FDD) mode, e.g., DL and UL are both 10 MHz or 20 MHz transmission bandwidth each, LTE-A may be able to operate in asymmetric configurations such as DL 40 MHz paired with UL 20 MHz.

In addition, composite aggregate transmission bandwidths may also be possible with LTE-A, e.g., in the DL, a first 20 MHz carrier and a second 10 MHz carrier are paired with an UL 20 MHz carrier and so on. The composite aggregate transmission bandwidths may not necessarily be contiguous in the frequency domain, e.g., the first 10 MHz component carrier in the above example may be spaced by 22.5 MHz in the DL band from the second 5 MHz DL component carrier. Alternatively, operation in contiguous aggregate transmission bandwidths may also be possible, e.g., a first 15 MHz DL component carrier is aggregated with another 15 MHz DL component carrier and paired with a 20 MHz UL carrier.

These different configurations for LTE-A carrier aggregation and support for flexible bandwidth arrangements are illustrated as examples in FIG. 2. FIG. 2 shows four component carriers (CCs) from the same eNB (F1, F2, F3, and F4 on different frequencies) with the same or different geographical radio coverage. Operationally, all or several of the CCs may be organized as a component carrier set by the eNB. One or more or all of the CCs in the set may provide the traditional LTE cell service and other LTE-A services, such as CC-F1, CC-F2, and CC-F3.

From the above, among the component carriers, an “anchor carrier” is a component carrier that serves to guide through the WTRU LTE-A cell search, to facilitate the WTRU to synchronize with the LTE-A cell, and to obtain information from the cell. One or more CCs may serve as anchor carriers (also referred to as “primary CCs” or “special cells”). Given that the WTRU in LTE-A may be camped on one of the several anchor carriers of an LTE-A eNB carrier set or the cell set in the Idle mode, the cell reselection procedures and the related measurement actions are proposed for the WTRU to operate within the LTE-A system.

### SUMMARY

A method and apparatus for performing anchor carrier reselection measurements and ranking in LTE-A are disclosed. The measurements are first determined by whether a non-serving anchor carrier has a higher reselection priority than a serving anchor carrier. Other non-serving anchor carrier measurements are started by checking the serving anchor measured results against non-serving anchor carrier measurement thresholds, including the parameter S-IntraCellSearch for measuring and ranking the intra-cell anchor carriers ahead of other non-serving anchor carriers.

### BRIEF DESCRIPTION OF THE DRAWINGS

A more detailed understanding may be had from the following description, given by way of example in conjunction with the accompanying drawings wherein:

FIG. 1 shows an example of the OFDMA carrier used in LTE;

FIG. 2 shows an example of multiple component carriers from an eNB in LTE-A;

FIG. 3 shows an LTE wireless communication system/access network;

FIG. 4 is an example block diagram of the LTE wireless communication system shown in FIG. 3;

FIG. 5 is a flowchart of a method applying anchor carrier reselection measurement rules; and

FIGS. 6A-6B are a flowchart of an alternate method applying anchor carrier reselection measurement rules.

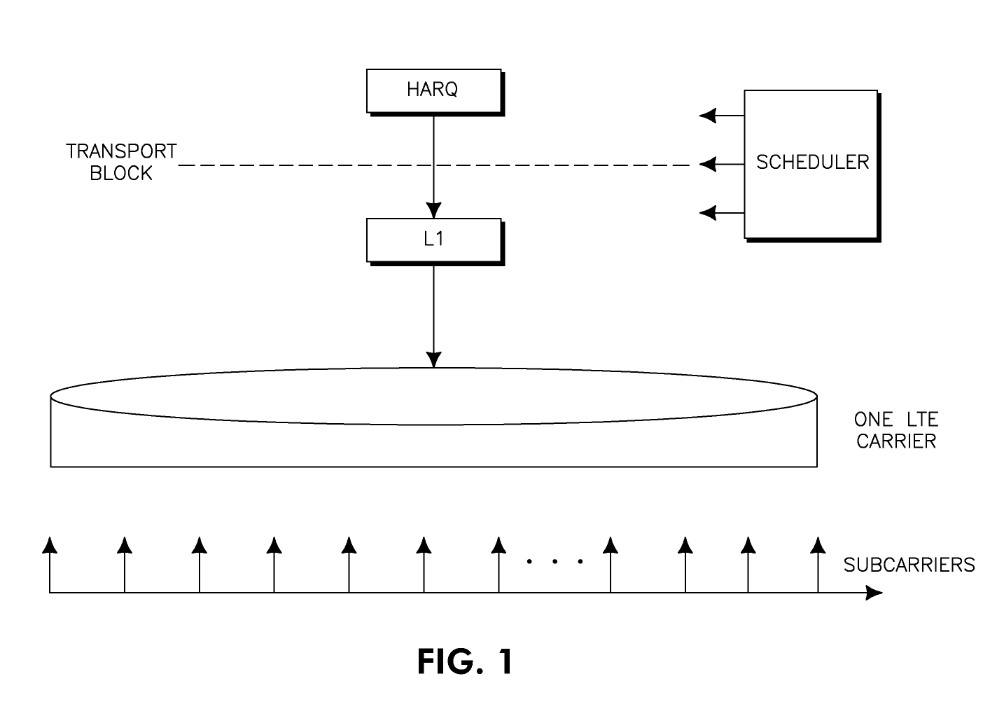

### DETAILED DESCRIPTION

When referred to hereafter, the term “wireless transmit/receive unit (WTRU)” includes, but is not limited to, a user equipment (UE), a mobile station, a fixed or mobile subscriber unit, a pager, a cellular telephone, a personal digital assistant (PDA), a computer, or any other type of user device capable of operating in a wireless environment. When referred to hereafter, the term “base station” includes, but is not limited to, a Node B, an eNodeB, a site controller, an access point (AP), or any other type of interfacing device capable of operating in a wireless environment.

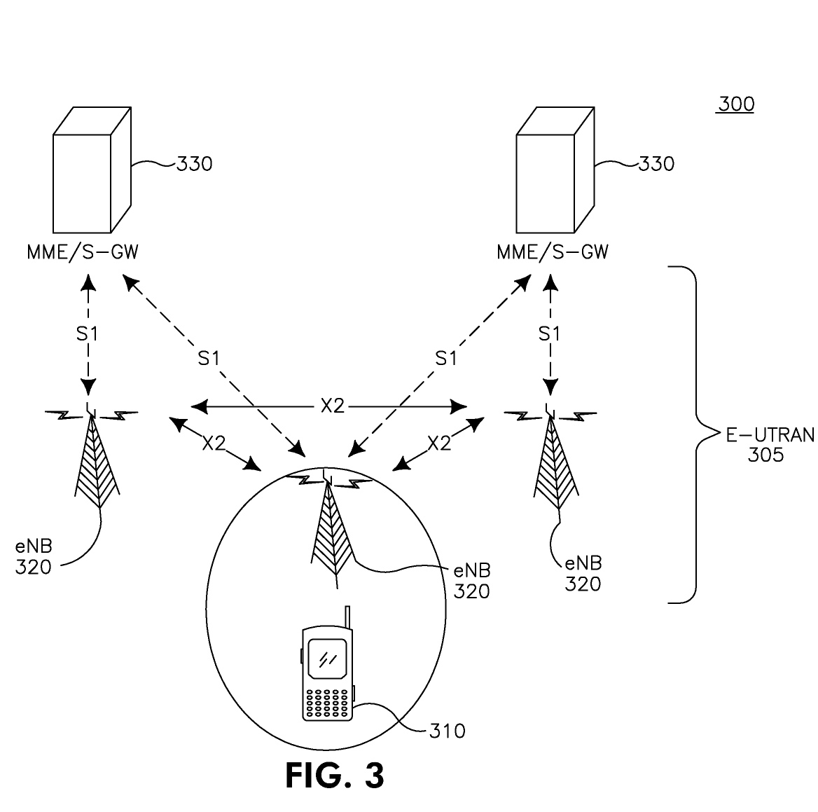

FIG. 3 shows a Long Term Evolution (LTE) wireless communication system/access network 300 that includes an Evolved-Universal Terrestrial Radio Access Network (E-UTRAN) 305. The E-UTRAN 305 includes several evolved Node Bs, (eNBs) 320. The WTRU 310 is in communication with an eNB 320. The eNBs 320 interface with each other using an X2 interface. Each of the eNBs 320 interface with a Mobility Management Entity (MME)/Serving GateWay (S-GW) 330 through an S1 interface. Although a single WTRU 310 and three eNBs 320 are shown in FIG. 3, it should be apparent that any combination of wireless and wired devices may be included in the wireless communication system access network 300.

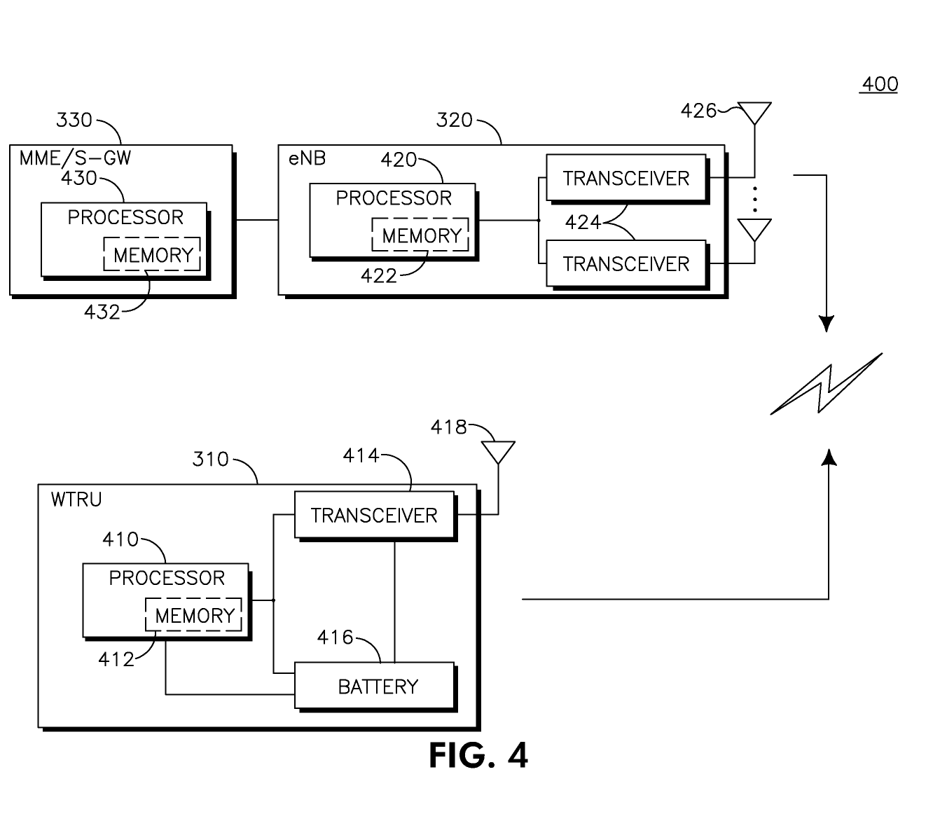

FIG. 4 is an example block diagram of an LTE wireless communication system 400 including the WTRU 310, the eNB 320, and the MME/S-GW 330. As shown in FIG. 4, the WTRU 310 and the eNB 320 are configured to perform a method of anchor carrier reselection and cell reselection.

In addition to the components that may be found in a typical WTRU, the WTRU 310 includes a processor 410 with an optional linked memory 412, at least one transceiver 414, an optional battery 416, and an antenna 418. The processor 410 is configured to perform a method of anchor carrier reselection or an LTE-A cell reselection. The transceiver 414 is in communication with the processor 410 and the antenna 418 to facilitate the transmission and reception of wireless communications. In case a battery 416 is used in the WTRU 310, it powers the transceiver 414 and the processor 410.

In addition to the components that may be found in a typical eNB, the eNB 320 includes a processor 420 with an optional linked memory 422, transceivers 424, and antennas 426. The processor 420 is configured to facilitate a method of anchor carrier reselection and cell reselection. The transceivers 424 are in communication with the processor 420 and antennas 426 to facilitate the transmission and reception of wireless communications. The eNB 320 is connected to the Mobility Management Entity/Serving GateWay (MME/S-GW) 330 which includes a processor 430 with an optional linked memory 432.

Inter-Anchor Carrier Reselection and Measurement Configurations

In an LTE-A system, an eNB may have configured more than one component carrier (CC) with each CC operating on a different frequency range. Apart from the frequency range difference, the eNB may also have the CCs on different radio coverage areas, have the CCs configured to be LTE R8 compatible or not, or even have some of the CCs without the cell service functionality but acting as pure resource carriers. Given those functional differences, not all the CCs from an eNB are suitable for an LTE-A WTRU to camp on to receive desired cell services when in Idle mode. Hence, the E-UTRAN may explicitly indicate such carrier differences. Those CCs that are designated to provide the cell-like functionalities from an eNB in LTE-A may be configured as a set (referred to as, for example, an anchor carrier set or a downlink CC set) in the system information to provide the directives to LTE-A WTRUs for appropriate LTE-A operations.

It is noted that an anchor carrier as referred to herein is one of the CCs from an eNB that broadcasts a cell identity and the system information. The anchor carrier provides paging, UL random access, and other basic R8 LTE cell services such as the network attachment and security configuration to all the LTE-A WTRUs that have camped on the cell through cell search and cell selection. Other similar names for an anchor carrier may include, but are not limited to: “base CC,” “primary CC,” “special cell,” “serving cell,” “serving CC,” or other names for the similar functionalities of a component carrier.

In LTE-A, the system information broadcast from each anchor carrier may have parameters specific for each of the other anchor carriers, if more than one anchor carrier is configured by an eNB to provide the LTE-A cell services. To facilitate the intra-cell reselection (defined herein to be an LTE-A WTRU Idle mode reselection process among all of the anchor carriers from a single eNB), some LTE-A per anchor carrier system information parameters may include anchor carrier access information, carrier-specific access parameters, carrier reselection parameters, and neighbor anchor carrier information.

The anchor carrier access information may include new information elements such as whether the carrier is “carrier barred” or is a “carrier reserved for operator use/maintenance.” Alternatively, the LTE R8 “cell barred” and “cell reserved for operator use/maintenance” parameters may have the new meaning of carrier barred or operator reserved when used under the LTE-A carrier aggregation context. The WTRU may not access a carrier that is indicated as barred. A timing parameter may be associated with the barred status of the carrier. The “carrier reserved for operator use” parameter indicates whether or not the anchor carrier is reserved by the operator with respect to certain WTRU access classes. WTRUs may not attempt to reselect to an anchor carrier that is barred, or WTRUs with lower access classes may not attempt to reselect to an anchor carrier that is reserved or a carrier that is barred against lower access class WTRUs.

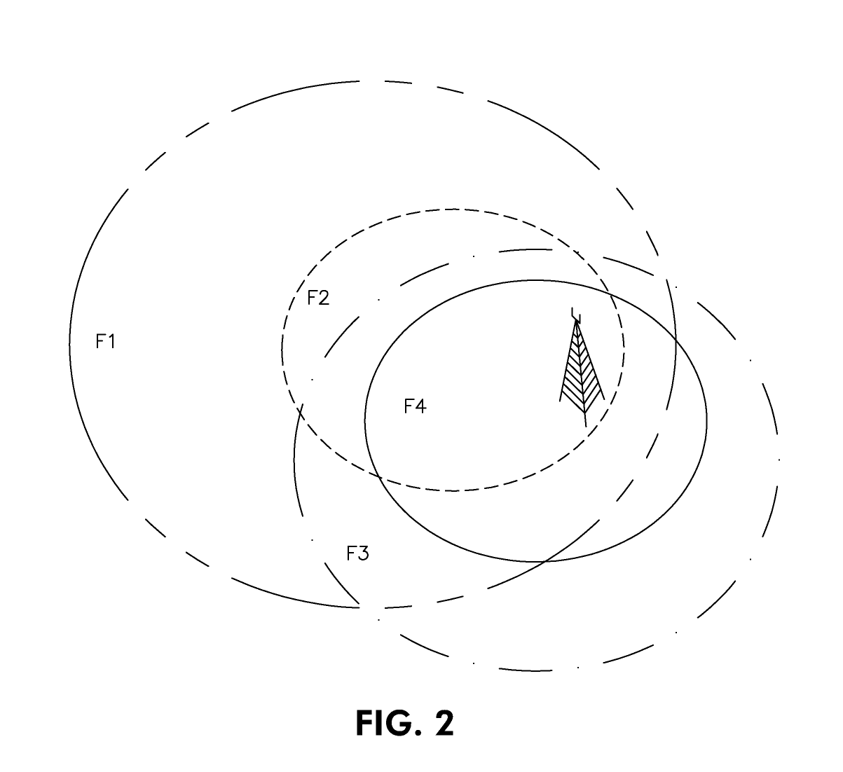

It is noted that additional carriers may be used in situations where, for example, there is a large bandwidth request that exceeds the bandwidth of the anchor carrier. In such circumstances, a new carrier, called a “resource carrier,” is added and is used to handle the additional bandwidth, e.g., F4 in FIG. 2. The resource carrier may in one embodiment only be allocated by the eNodeB and may advertise itself as “carrier barred.” In another embodiment, the resource carrier may not provide any LTE cell signals and identities to be found by the WTRU during cell search. In either of these embodiments, the WTRU does not recognize the resource carrier as an anchor carrier. By doing so, the WTRU should not attempt to attach to (i.e., camp on) the resource carrier or obtain security information from the resource carrier in the cell selection and cell reselection operations.

The carrier-specific access parameters include a maximum power parameter (P_{EMAX}_{_{—}}_{H}) for the UL access since each anchor carrier may have its own paired UL carrier or an UL carrier configured/assigned to share with other DL carriers (in terms of UL random access). The P_{EMAX}_{_{—}}_{H} imposed by the LTE-A cell in the system information is the maximum transmit power used by a WTRU when transmitting on the UL in the cell configured by the eNB. For UL power control (for both random access and physical UL shared channel (PUSCH)/physical UL control channel (PUCCH)), the WTRU may use the minimum value between P_{EMAX}_{_{—}}_{H} and the WTRU's capability UL maximum transmit power as the maximum allowed transmit power.

The carrier reselection parameters include q-QrcvlevMin or q-QqualMin, since LTE-A anchor carriers are on a different frequency spectrum, the WTRU DL signal strength and/or quality requirements from them may be different. These parameters are also carrier-specific.

Other carrier reselection parameters may include, but are not limited to:
anchor carrier reselection priority, expressed either globally or within the LTE-A cell;
neighbor carrier reselection priorities, expressed either globally or within the LTE-A cell;
q-QrcvLevMin, which indicates a minimum signal strength that the WTRU has to receive to camp on the anchor carrier under cell selection or reselection;
q-QqualMin, which indicates a minimum signal-to-interference plus noise ratio (SINR) that the WTRU has to receive to camp on the anchor carrier under cell selection or reselection;
q-Hyst, which specifies a hysteresis value for ranking criteria applied to LTE-A intra-cell inter-carrier reselection or to intra-frequency, inter-frequency cell reselections;
s-IntraCellSearch, which specifies a measurement threshold (when the serving cell signal strength or quality falls below) to start the intra-LTE-A-cell (or intra-anchor-CC-set or intra-DL-CC-set) neighbor anchor carrier measurements;
s-IntraSearch, which specifies a measurement threshold (when the serving anchor carrier measured signal strength or quality falls below) to start intra-frequency neighbor cell/anchor carrier measurements for intra-frequency cell reselection; and
s-InterSearch, which specifies a measurement threshold (when the serving anchor carrier strength or quality falls below) to start inter-frequency neighbor cell/anchor carrier measurements for inter-frequency cell reselection.

The neighbor/adjacent anchor carriers include intra-LTE-A cell anchor carriers, intra-frequency LTE-A cell anchor carriers, and inter-frequency LTE-A cell anchor carriers. The parameters for anchor carrier configuration consist of one or more of the following.

One or more anchor carriers, each with a DL and a corresponding UL counterpart (the DL anchor carriers may share one UL anchor carrier for random access to the cell).

The anchor carrier bandwidth figures, which include the standard R8 LTE bandwidth (1.4, 3, 5, 10, 15, and 20 MHz) and non-R8 standard bandwidth figures (to facilitate flexible LTE spectrum allocation) but are multiples of the LTE raster width (100 KHz).

The center frequency of the respective anchor carriers in the form of an absolute evolved universal terrestrial radio access (E-UTRA) absolute radio frequency channel number (EARFCN) in the total radio frequency channel number (RFCN) space, i.e., between 0 and 65535, or relative offset numbers with respect to the overall FDD EARFCN range, one for DL and one for UL. The offset number is given with respect to 0 in the DL (DL EARFCN numbers 0 to 5849) and is given with respect to 18000 (UL EARFCN 18000 to 23849) in the UL. For instance, a 357 in DL represents 357 in Band-1 DL, while a 422 in UL represents 18422 in the UL of Band-1. For TDD, an offset number with respect to the E-UTRA TDD frequency number range 36000 is used (TDD DL/UL shared band, 36000 to 39649), e.g., 274 represents the EARFCN 36274 in Band-34.

A band index number and the offset numbers (one for DL, and one for UL) with respect to the starting range number of the particular EUTRA band may also be used. For example, band number 4, DL 26, UL 55 represents the EARFCN 1976 (1950+26) in DL and EARFCN 20005 (19950+55) in the UL of EUTRA Band-4. 1950 is the starting DL ERFCN for LTE Band-4, while 19950 is the starting UL EARFCN for Band-4. The signaling of the band number is optional in case the anchor carrier is on the same band as the serving anchor carrier.

Anchor Carrier Reselection Measurement Rules

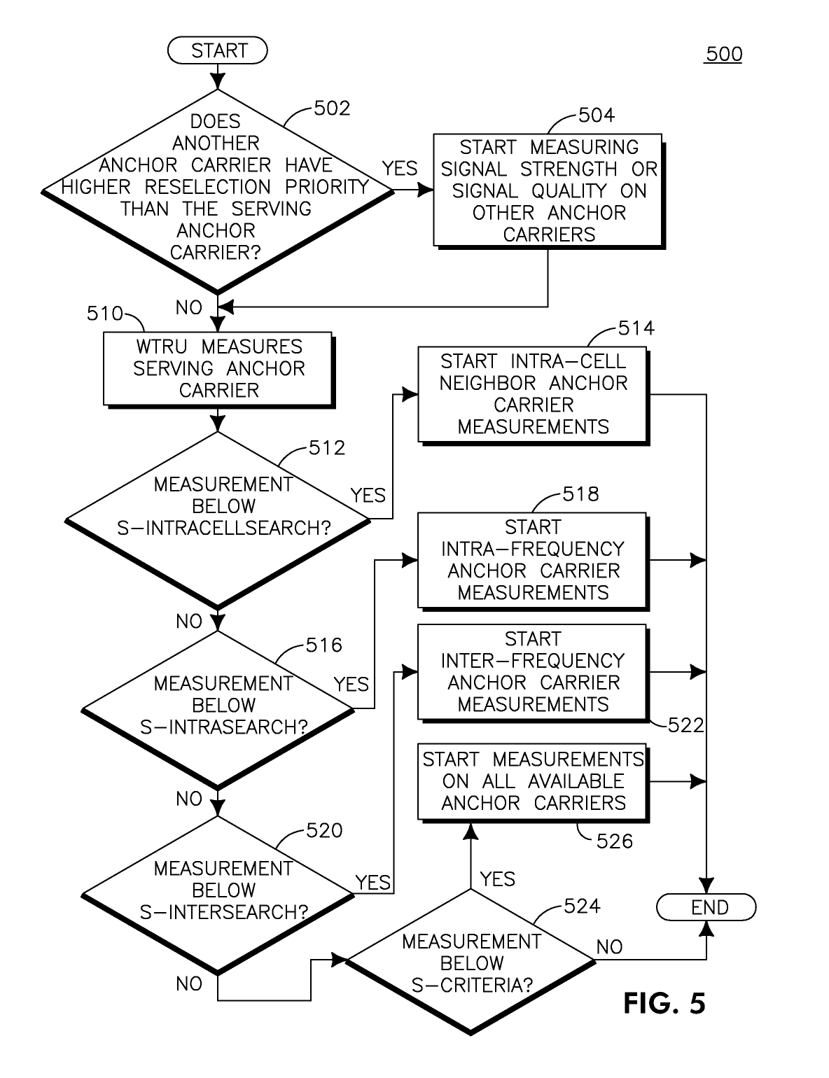

FIG. 5 is a flowchart of a method 500 applying anchor carrier reselection measurement rules. The method 500 begins by determining whether an anchor carrier reselection condition has been met. Reselection measurement on a different anchor carrier may start if the serving anchor carrier is in one of the following conditions in the WTRU Idle mode. With respect to the current serving anchor carrier reselection priority: if an intra-cell anchor carrier has a higher reselection priority, if an intra-frequency anchor carrier on another LTE-A cell has a higher reselection priority, or if an inter-frequency anchor carrier on another LTE-A cell has a higher reselection priority (step 502).

If another anchor carrier has a higher reselection priority than the serving anchor carrier, then the WTRU may start measuring the signal strength or the signal quality on those other anchor carriers with higher reselection priorities (step 504). The WTRU may then measure the serving anchor carrier signals (step 510).

If several anchor carriers have a higher priority than the serving anchor carrier, then the order of taking measurements among the anchor carriers may be based on the given priority or based on the order that the anchor carriers are listed in the system information if they have the same priority. It is noted that the reselection priorities may be changed in a system information update. A WTRU in Idle mode may check the reselection priority change and start performing reselection measurements on the anchor carriers if the reselection priorities on these carriers become higher.

If the serving anchor carrier has a higher reselection priority than any other anchor carrier (step 504), the WTRU may also then measure the signal strength or the signal quality of the serving anchor carrier (step 510). The WTRU may also periodically measure its serving anchor carrier to ensure that the receiving signal strength and/or signal quality is better than or equal to the cell/anchor selection criteria. If the measured serving anchor carrier signal strength or signal quality falls below the following LTE-A cell/anchor carrier reselection measurement thresholds, the LTE-A cell reselection or anchor carrier reselection measurements may begin.

A determination is made whether the current anchor carrier measured results S (see below for the S-criteria) from Qᵣₓₗₑᵥₘₑₐₛ or Q_{qualmeas} falls below the S-IntraCellSearch parameter (step 512). If the current anchor carrier measured results are below S-IntraCellSearch, then the intra-cell neighbor anchor carrier measurements may be started (step 514); i.e., start measuring the component carriers in the anchor carrier set.

If the current anchor carrier measured results are not below S-IntraCellSearch (step 512), then a determination is made whether the current anchor carrier measured results S from Qᵣₓₗₑᵥₘₑₐₛ or Q_{qualmeas} falls below the S-IntraSearch parameter (step 516). If the current anchor carrier measured results are below S-IntraSearch, then the intra-frequency neighbor cell or neighbor anchor carrier measurements may be started (step 518).

If the current anchor carrier measured results are not below S-IntraSearch (step 516), then a determination is made whether the current anchor carrier measured results S from Qᵣₓₗₑᵥₘₑₐₛ or Q_{qualmeas} falls below the S-InterSearch parameter (step 520). If the current anchor carrier measured results are below S-InterSearch, then the inter-frequency neighbor cell or neighbor anchor carrier measurements may be started (step 522).

If the current anchor carrier measured results are not below S-InterSearch (step 520), then a determination is made whether the current anchor carrier measured results Qᵣₓₗₑᵥₘₑₐₛ or Q_{qualmeas} fall below the cell/anchor selection criteria (S-criteria; step 524). If the current anchor carrier measured results are below the S-criteria, then the WTRU may start measuring all available anchor carriers (intra-cell, inter-cell, inter-frequency) to find a better anchor carrier for reselection (step 526). It is noted that when a non-serving anchor carrier is shown by system information as being “non-accessible” by a particular WTRU, the WTRU does not need to measure that non-serving anchor carrier.

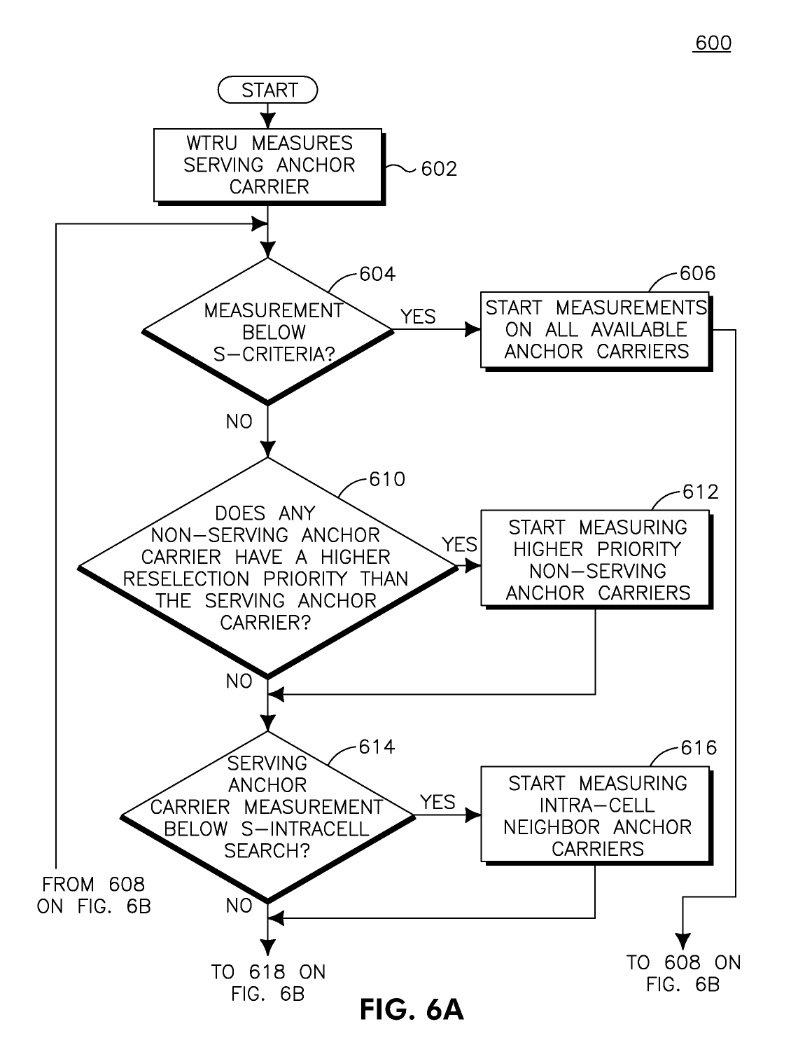

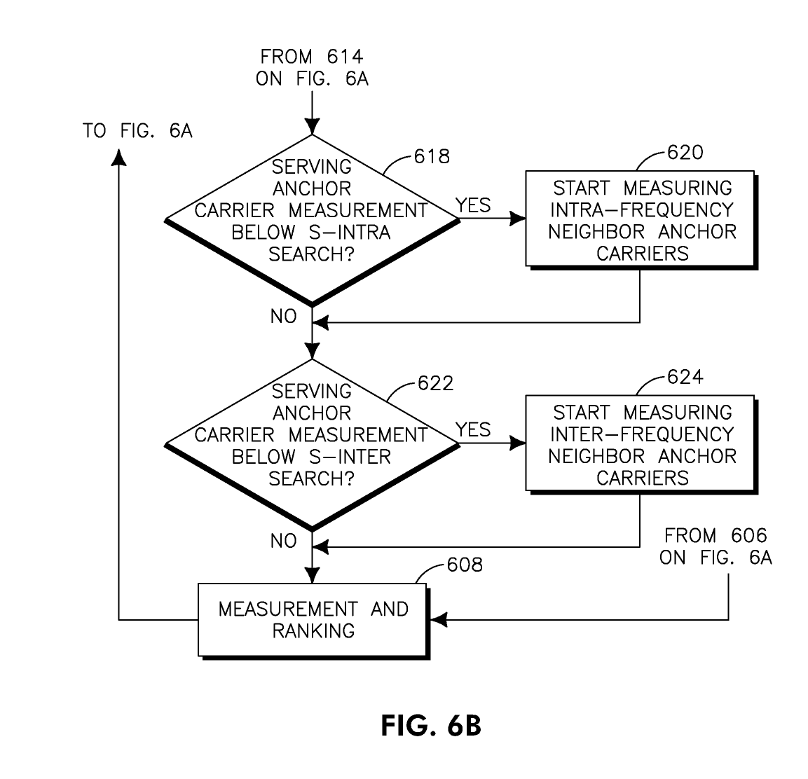

FIGS. 6A-6B are a flowchart of an alternate method 600 applying anchor carrier reselection measurement rules. The WTRU measures the serving anchor carrier (step 602) and compares the measurement results against the S-criteria. If the serving anchor carrier measurement is below the S-criteria (step 604), then measurements on all known non-serving anchor carriers are started (step 606). After the measurements on all available non-serving anchor carriers are taken, the measurement results are used to rank the carriers for reselection (step 608).

If the serving anchor carrier measurement is not below the S-criteria (step 604), then a determination is made whether there is a non-serving anchor carrier with a higher reselection priority than the serving anchor carrier (step 610). If there is a non-serving anchor carrier with a higher reselection priority than the serving anchor carrier, then measurements on the higher priority non-serving anchor carriers are started (step 612).

If there are no non-serving anchor carriers with a higher priority than the serving anchor carrier (step 610), then the serving anchor carrier measurement is compared to the S-IntraCellSearch parameter. If the serving anchor carrier measurement is below the S-IntraCellSearch parameter (step 614), then measurements on intra-cell neighbor anchor carriers are started (step 616).

If the serving anchor carrier measurement is not below the S-IntraCellSearch parameter (step 614), then the serving anchor carrier measurement is compared to the S-IntraSearch parameter. If the serving anchor carrier measurement is below the S-IntraSearch parameter (step 618), then measurements on intra-frequency neighbor anchor carriers are started (step 620).

If the serving anchor carrier measurement is not below the S-IntraSearch parameter (step 618), then the serving anchor carrier measurement is compared to the S-InterSearch parameter. If the serving anchor carrier measurement is below the S-InterSearch parameter (step 628), then measurements on inter-frequency neighbor anchor carriers are started (step 624).

If the serving anchor carrier measurement is not below the S-InterSearch parameter (step 622) or after the inter-frequency anchor carrier measurements have been taken (step 624), the measurement results are used to rank the carriers for reselection (step 608).

It is noted that the comparison of the serving anchor carrier measured result against the thresholds (the different S-criteria parameters) may be done in any order; the order shown in FIG. 6 is an example of one implementation. The order of evaluating the thresholds in FIG. 6 implies that the absolute values of the thresholds assigned to the WTRU are related as: S-IntraCellSearch≧S-IntraSearch≧S-InterSearch≧S-Criteria. Based on this relationship, the resulting evaluation may include some intra-cell CCs (step 614) but not other CCs, for example, the inter-frequency CCs (step 622).

The comparison order may depend on the absolute values given to these thresholds. The example shown in FIG. 6 illustrates that the WTRU compares the highest threshold first and includes those CCs defined for that threshold only, and the next highest threshold second, and so on. Alternatively, the WTRU may compare the lowest value threshold first and evaluate the thresholds in the order of lowest to highest. In this implementation, once a lower threshold meets the measurement, all of the higher thresholds would also meet the measurement evaluation rule, and thus all those CCs with higher threshold values may be included in the final measurements.

One embodiment of the LTE-A anchor carrier selection/reselection criteria is as follows.

Spower=(Qᵣₓₗₑᵥₘₑₐₛ−q-QrcvLevMin−ULPowerCompensation)>0 Equation (1)

when the signal strength measurement is used; or

Squality=(Q_{qualmeas}−q-QqualMin−ULPowerCompensation)>0 Equation (2)

when the signal quality measurement is used.

In both Equation 1 and Equation 2, ULPowerCompensation=min (P_{EMAX}_{_{—}}_{H}, UE_max_tx_power), where P_{EMAX}_{_{—}}_{H} is as defined above and UE_max_tx_power is the maximum possible transmit power of the WTRU.

Hence, the selection/reselection criteria in LTE-A to a new anchor carrier or a cell may be based on both the Spower>0 and the Squality>0 in general, unless it is specified by the network that only one of the measurements is used.

The results of the anchor carrier measurement Q_{meas,s} (the result from the current serving carrier) and the Q_{meas,n} (measured result(s) from one or more other non-serving anchor carriers) are used to calculate a ranking value Rₛ (for the serving carrier) and an ordered list of Rₙ values (one value of Rₙ for each of the other/neighbor carriers) among a number of measured carriers. The Rₙ list is used to determine the order of which another carrier may be used as the reselection candidate to compare against the Rₛ (Rₙ>Rₛ) and to perform the cell suitability check.

In one embodiment, the resulting Rₛ and Rₙ(s) may be normalized with the assigned reselection priority of each anchor carrier to reflect the priority factor in the final carrier reselection determination. That is, the R value (rank result) with Rₛ for the serving anchor carrier and Rₙ for the neighbor anchor carrier may be normalized with Pₘ/Pₜ, where Pₘ is the assigned priority of the measured anchor carrier and Pₜ is the maximum priority value in scale. For example, if there are eight reselection priority levels, then Pₜ is 8 and if the serving anchor carrier is assigned a priority of 5, then the normalizing scale factor is Pₘ/Pₜ=5/8. It is noted that if a carrier is not assigned a reselection priority, it assumes the same priority as the anchor carrier where it is broadcast or it assumes a default reselection priority or it inherits the reselection priority from a previous entry in the carrier list.

The measured results on the various anchor carriers may be ranked as follows:

Rₛ=Q_{meas,s}+Q_{Hyst} Equation (3)

Rₙ=Q_{meas,n}−Q_{offset} Equation (4)

For all anchor carriers ranked numerically equal, the higher reselection priority carriers (if Rₙ is not normalized with respect to reselection priority) and the intra-cell anchor carriers may be listed ahead of the intra-frequency other cell anchor carriers, and it in turn may be listed ahead of the inter-frequency other cell anchor carriers. This is because anchor carriers defined for intra-cell (or anchor carrier set, DL CC set, or other set of carriers from the same eNB) reselection are from the same eNB. Therefore, if a carrier reselection resulted in selecting the same eNB, it is most likely to result in no signaling overhead or the least network signaling overhead as compared to changing to a different eNB. The signaling overhead is due to the carrier reselection with the WTRU context transfer (between eNBs) and the possible tracking area update (changing the eNB may result in changing the WTRU tracking area) signaling and operation.

If more than one anchor carrier measures better than the current serving anchor carrier, they may be ranked to determine the candidacy order. The top ranked anchor carrier (or cell) may first be checked for suitability by the WTRU, followed by the other carriers in rank order.

If a better ranked neighbor anchor carrier is found (through a number of measured results or through a time period, i.e., the T_{reselection} timer) and the suitability check on that anchor carrier is successful, then the WTRU reselects to that anchor carrier, provided the WTRU has been camped on the current anchor carrier for more than x seconds (x≧1).

Anchor Carrier Reselection Notification

To facilitate optimal paging, the WTRU may optionally send a notification to the eNB/LTE-A Cell/E-UTRAN notifying it of the occurrence of the anchor carrier reselection. In this way, the LTE-A paging may be transmitted over only the one anchor carrier within an LTE-A anchor carrier set/DL CC set cell instead of transmitting over many anchor carriers from the eNB.

Through a current random access to notify the network, an LTE-A anchor carrier/serving cell reserves some random access channel (RACH) resources (in terms of preamble, frequency, and time) in the corresponding UL anchor carrier RACH channel for intra-cell anchor carrier reselection notification. The information of such resources may be obtained by Idle mode LTE-A WTRUs by acquiring a master information block (MIB) and system information blocks (SIBs).

Similarly, an LTE-A cell reserves some special RACH resources (in terms of preamble, frequency, and time) in the corresponding UL anchor carrier RACH channel for anchor carrier reselection notification. The information of such resources may be obtained by Idle mode LTE-A WTRUs by acquiring a MIB and SIBs. The WTRU may encode the DL target anchor carrier identity (within the same LTE-A cell) and the WTRU identity in the special reserved preamble/signature to notify the network. The WTRU may encode the WTRU identity in the special UL preamble/signature if the target DL anchor carrier may be derived by the eNodeB, i.e., if the target UL/DL anchor carriers have a one-to-one mapping and if the reselection is intra-cell. If the reselection is inter-cell (intra-frequency or inter-frequency), then together with the WTRU identity, the WTRU encodes the source LTE-A cell identity and the target DL anchor carrier identity if the reselection does not involve a tracking area change.

General Measurement and Reporting for an LTE-A Cell

In LTE-A, when in the Connected mode, the WTRU measurement (of received signal strength, signal quality, and path loss) on various quantities may be made over any of the following: a component carrier, several carriers, or all carriers of an LTE-A cell. A single component carrier, especially the anchor carrier, may be used where the network signals the offset (or the parameters to compute the offset) as a threshold for reporting general measurements or particular events. Several component/anchor carriers within an LTE-A cell may be used as specified in the broadcast channel (BCH). The network may signal the offset (or the parameters to compute the offset) between different component carriers for reporting measurements or events.

Alternatively, CCs from a same eNB on contiguous frequency spectrum may be represented by one CC. This representative CC may be explicitly assigned or configured by the network, or it may be represented by a default CC with either the lowest frequency CC, the highest frequency CC, or the currently serving CC from the WTRU's point of view.

In the scenario of non-contiguous carrier aggregation, the measurement and reporting for measurements may include at least one component carrier per non-contiguous carrier-group, especially the anchor carrier(s). Alternatively, only one component carrier (preferably the anchor carrier) within the non-contiguous carrier-group which includes the current anchor carrier may be used.

The measurement report may report measured results on a component carrier, especially the anchor carrier; several component carriers and/or anchor carrier(s); in the scenario of non-contiguous carrier aggregation, one component carrier per non-contiguous carrier-group; or the aggregation of the measured results over several or all component carriers of an LTE-A cell as specified in the BCH.

Although features and elements are described above in particular combinations, each feature or element may be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

What is claimed is:

1. A method for determining anchor carrier reselection candidates, comprising:
performing measurements on a serving anchor carrier;
determining whether to perform measurements on non-serving anchor carriers; and
ranking the measured non-serving anchor carriers to determine a reselection candidacy order for the measured non-serving anchor carriers.

2. The method according to claim 1, wherein performing measurements on the serving anchor carrier and on the non-serving anchor carriers includes measuring signal strength or signal quality.

3. The method according to claim 1, wherein the determining includes determining whether the serving anchor carrier measurements are below a predetermined threshold.

4. The method according to claim 3, wherein the predetermined threshold is a cell reselection criteria and the method further comprises:
on a condition that the serving anchor carrier measurement is below the cell reselection criteria, performing measurements on all known non-serving anchor carriers.

5. The method according to claim 3, wherein the predetermined threshold is an intra-cell search criteria and the method further comprises:
on a condition that the serving anchor carrier measurement is below the intra-cell search criteria, performing measurements on intra-cell neighbor anchor carriers.

6. The method according to claim 3, wherein the predetermined threshold is an intra-frequency search criteria and the method further comprises:
on a condition that the serving anchor carrier measurement is below the intra-frequency search criteria, performing measurements on intra-frequency neighbor anchor carriers.

7. The method according to claim 3, wherein the predetermined threshold is an inter-frequency search criteria and the method further comprises:
on a condition that the serving anchor carrier measurement is below the inter-frequency search criteria, performing measurements on inter-frequency neighbor anchor carriers.

8. The method according to claim 1, wherein the determining includes determining whether a non-serving anchor carrier has a higher reselection priority than the serving anchor carrier and the method further comprises:
on a condition that a non-serving anchor carrier has a higher reselection priority than the serving anchor carrier, performing measurements on the non-serving anchor carriers having a higher reselection priority than the serving anchor carrier.

9. The method according to claim 1, wherein on a condition that more than one anchor carrier has a same ranking, ranking an intra-cell anchor carrier ahead of an intra-frequency anchor carrier and ranking an intra-frequency anchor carrier ahead of an inter-frequency anchor carrier.

10. The method according to claim 1, further comprising:
normalizing the ranking based on a predetermined number of priority levels.

11. A wireless transmit/receive unit, comprising:
an antenna;
a transceiver in communication with the antenna; and
a processor in communication with the transceiver, the processor configured to:
perform measurements on a serving anchor carrier;
determine whether to perform measurements on non-serving anchor carriers; and
rank the measured non-serving anchor carriers to determine a reselection candidacy order for the measured non-serving anchor carriers.

12. A method for determining whether a wireless transmit/receive unit (WTRU) may access a carrier, comprising:
receiving an indication whether the carrier is barred or reserved for use; and
on a condition that the indication indicates that the carrier is barred or reserved for use, preventing the WTRU from accessing the carrier.

13. The method according to claim 12, wherein a carrier that is reserved for use is reserved for predetermined WTRU access classes and a WTRU with a lower access class may not access the reserved carrier.

14. The method according to claim 12, wherein on a condition that the carrier is barred, the method further comprising:
determining whether a timer associated with the barred status of the carrier has expired; and
on a condition that the timer has expired, permitting the WTRU to attempt to access the carrier.

15. A method for determining whether a carrier is suitable for a wireless transmit/receive unit (WTRU) to camp on, the method comprising:
receiving system information;
examining the system information to determine a functionality of the carrier, wherein the carrier functionality includes at least one of: frequency range, radio coverage area, Long Term Evolution version compatibility, or resource carrier status; and
using the carrier functionality to determine whether the carrier is suitable for a WTRU to camp on.

16. A method for measuring a carrier by a wireless transmit/receive unit (WTRU) in WTRU operating state measurement, the method comprising:
measuring at least one of: received signal strength, received signal quality, or path loss; and
measuring on any one of: a single component carrier, several carriers, or all carriers of a cell.

17. The method of claim 16, wherein on a condition that there are several carriers from a same enhanced Node B on a contiguous frequency spectrum, the measuring including measuring one carrier as being representative of the several carriers.

18. The method of claim 17, wherein the one carrier is identified by any one of: explicit assignment by the network, explicit configuration by the network, a default carrier, a lowest frequency carrier of the several carriers, a highest frequency carrier of the several carriers, or a carrier currently serving the WTRU.
